(19) United States
(12) Patent Application Publication
(10) Pub. No.: US 2010/0119989 A1
(43) Pub. Date: May 13, 2010

(54) RETRACTING DEVICE

(75) Inventor: John Raybuck, Los Angeles, CA (US)

Correspondence Address: DISCUS DENTAL, LLC, 8550 HIGUERA STREET, CULVER CITY, CA, 90232, US

(73) Assignee: DISCUS DENTAL, LLC, Culver City, CA (US)

(21) Appl. No.: 12/617,457

(22) Filed: Nov. 12, 2009

Related U.S. Application Data
(60) Provisional application No. 61/113,993, filed on Nov. 12, 2008.

(51) Int. Cl. A61C 17/10; A61C 5/00; A61C 5/14; A61C 13/38

(52) U.S. Cl. 433/93; 433/140; 433/136; 264/16

(57) ABSTRACT

The present invention is related to devices utilized for retraction of the lips, tongue and oral cavity during dental procedures. In particular, the invention relates to a flexible or semi-flexible oral device used to comfortably and quickly retract the patient's lips to properly expose the patient's teeth and gums for dental procedures.

### FIELD OF THE INVENTION

The present invention relates to oral retracting devices in general. Specifically, the present invention relates to devices utilized for retraction of the lips, tongue and oral cavity during dental procedures. More specifically, the invention relates to a flexible or semi-flexible oral device used to comfortably and quickly retract the patient's lips to properly expose the patient's teeth and gums for dental procedures.

### BACKGROUND

Dental practitioners utilize various retraction devices for a variety of tasks and procedures, including in-office teeth whitening such as Zoom®! teeth whitening and BriteSmile® teeth whitening, along with various other dental procedures such as extractions, oral surgery, oral cancer screening, and the like. Many retractors are uncomfortable, do not fit various shapes and sizes of oral cavities, can cause patient injury, and take a long time to implement properly into the oral cavity. Also these retraction devices sometimes need ancillary devices to properly retract the patient for a particular procedure. Typical dental procedural time for use of one of these devices or systems in the oral cavity can be as long as up to 60 minutes or longer. In some instances, utilization of existing systems may also become a choking hazard if the patient is inappropriately placed in a horizontal position during the procedure. However, sometimes it is advantageous to have the patient in the horizontal position.

### SUMMARY OF THE INVENTION

The present invention relates to a comfortable, easy to implement, one-piece retraction device that minimizes or eliminates any risk of choking in any patient orientation, including when the patient is in a substantially horizontal position. The invention is useful for dental procedures, including chair-side whitening procedures, for example, Zoom®! and BriteSmile® whitening systems, and readily may be adapted and used for various other dental procedures.

According to the present invention, there is provided a retracting device for retracting portions of a user's mouth. The retracting device includes formations, which may be inter-engaging and/or non-inter-engaging with other dental tools or apparatus. The formations are adapted for repeated positioning at least a portion of a subject's mouth with respect to a light system, and/or an imaging film, and/or a dental tray, and/or an apparatus adapted for aspiration, such as an aspirator, and/or a suction tube. The retracting device includes a main body portion having a curved, continuous channel with a front wall and a rear wall. The front and rear walls each has a top portion and a bottom portion, joined by two side portions to form a substantial elliptical shape that once inserted into the oral cavity creates the desired teeth exposure. The front and rear walls each has an outside and an inside surface.

In one exemplary embodiment, the retracting device may include alignment formations that may be adapted for engaging various teeth whitening systems having lamps directed to the teeth to enhance the whitening process. The continuous channel may also serve to enhance the protection of the patient's lips from heat and unintended UV exposure during the activation of the light system. The walls of the channels may also be made to be inherently opaque.

The main body of the retracting device may include specific and concurrent flexibility and rigidity to allow the device at even one dimensional shape to fit a multitude of various oral cavity sizes.

In one aspect, the device has a curved, continuous concave channel having a front wall and a rear wall. The front and rear walls each having a top portion and a bottom portion, made integral or joined by two side portions to form a substantial elliptical shape channel that once inserted into the oral cavity creates the desired teeth exposure. The front and rear walls each has an outside and an inside surface. The concave channel may or may not be of uniform width and may be adapted for receiving the lips of the subject. In one embodiment, the front wall and the rear wall may both be of substantially the same height profile. In another embodiment, the front wall may be of a higher profile than the rear wall.

In one exemplary aspect, the front wall and rear wall may both be substantially continuous having substantially equal height profile all around. In another exemplary aspect, either the front wall or the rear wall may have a portion about the middle that is of a lower profile than the rest of the wall. In a further exemplary aspect, both the front wall and the rear wall may both have a portion about the middle that is of lower profile than the rest of the wall.

In one embodiment, the curve may allow the device to fit comfortably into the mouth. The concave channel allows for the device to completely and comfortably retract the upper and lower lips. On the backside of the curvature away from the front of the mouth once the device is inserted and at the apex of the lips, the rear wall about the side portion of the device may have a flange. In one aspect, the flange may have a longer profile than the front wall. The flange may aid in securing the device into the oral cavity. In one aspect, the flange may be symmetrical about the side portion. In another aspect, it may also be semi-flexible so as to allow for it to flex when needed during insertion into the oral cavity.

In one exemplary embodiment, a formation such as an alignment formation on the front of the device may be used to align the retraction device to various dental devices mentioned above, including a teeth-whitening lamp such as the Zoom® lamp. The alignment formations may be of any configuration, as long as they are adapted for matting, engaging or inter-engaging with a corresponding feature in a lamp system 400.

In one embodiment, this alignment formation may include two symmetrical formations, one on either side portion of the device. The formations may be formed or present on the outside surface of the outer wall. In one aspect, the formations may be in the form of protrusions protruding from the outer surface of the outside side wall of the side portion. According to one embodiment, the protrusion may be in the shape of a rectangular peg having a rectangular cross-section. According to another embodiment, the protrusion may be in the shape of a square peg. According to yet another embodiment, the protrusion may be in the form of a circular peg.

In another embodiment, this alignment formation may be created by a continuous blade-like feature that spans the entire front portion of the device, from side to side.

In one embodiment, the device may include a substantially cylindrical shape formation having an appropriate diameter, useful for alignment and orientation to other whitening systems, such as the BriteSmile® whitening system. The cylindrical shape formation may protrude from the main body of the retracting device.

According to one embodiment, the cylindrical shape formation may be connected to the alignment formation. According to another embodiment, the cylindrical shape formation may be part of a bite device, to be discussed in more detailed below.

In one aspect, a bite device having a suitable geometry may be attached to, for example, the rear surface of the rear wall forming the continuous channel, and may be, as noted above, used as a comfortable jaw rest or bite partition.

The bite partition may allow for appropriate spacing between the upper and lower teeth, and may also allow for a comfortable rest for the jaw. Since the time for a procedure may typically be as long, for example, as much as sixty minutes or longer, the bite partition may be manufactured from a soft or resilient material. In one embodiment, the bite partition may be manufactured to be soft or resilient while the continuous channel that retracts the upper and lower lips may be made to be stiffer, yet flexible. In another embodiment, both the bite partition and the channel may be of the same or similar softness.

In one embodiment, the bite partition may be in the shape of a letter “M”. The legs of the “M” shape may extend from or be attached to the outside surface of the rear wall of the continuous channel, substantially symmetrically about the device from side to side, one leg on each side. The backside of the bite partition may extend into the oral cavity during use, while the front side may not completely enter into the oral cavity during use. The “M” shape is shaped to allow for proper support of the upper and lower lips and also to allow for maximum access to the teeth during treatment. For example, the first molar or #3 to #14 teeth may be substantially exposed when the retracting device is in use. In any of these embodiments, the “M” shape bite partition may have attached to it or extends from it, a substantially cylindrical formation, as discussed above, which may extend towards the front side of the partition. The cylindrical formation may extends from or be attached to the “M” shape at the center or bottom of the “M”. The formation may be used with, for example, the BriteSmile® whitening system and thus may also act as an alignment feature to the lamp. In one embodiment, the alignment formation may be in the form of a peg, as noted above. In another embodiment, the alignment formation may be in the form of a blade, also noted above, with the cylindrical shape formation passing through the centre portion of the blade or the blade may be in two parts connected or made integral by the cylindrical shape formation.

In yet another embodiment, the bite partition may include geometry similar in shape to that of a “Y” except the “Y” shape may have on each side, an extension that extends symmetrically and parallel to the upper and lower channels towards the cheeks when the device is inserted into the oral cavity.

In still another embodiment, the bite partition may have the “M” geometry without the legs of the “M” being connected or attached to inside side wall of the rear wall of the curved continuous concave channel.

In yet still another embodiment, the “Y” shape bite device may be attached to or integral with the alignment center blade that spans continuously across the front side of the device. The attachment point may be to the front side of the device. This embodiment may also allow for added flexibility of the flange so that the flange may flex easily while being placed into the oral cavity and still maintains enough rigidity to retract the lips. In this embodiment, the cylindrical shape formation may also be attached to or form part of the leg of the Y shape formation.

In one embodiment, the cylindrical shape formation may be in the form of a tube, with the free end away from the bottom of the “M” shape or “Y” shape. The bottom of the “M” or “Y’ may have an opening, for example, a small opening, to allow fluid communication between the cylindrical tube and the inside of the oral cavity. The free end may be attached to or form part of an aspirator for providing aspiration during a dental process, to be discussed further below.

In one aspect, both the “M” and “Y” bite partitions may have top and bottom portions that are rounded. In another aspect, the portions may have sharp turns or corners.

Both the “M” and “Y” embodiments may be manufactured utilizing methods known in the art, including a two-shot injection molding process, injection molding including a two-shot injection molding, and insert injection molding. Two shot injection molding may have the ability to produce complex structures, using one or two different polymers at the same time during one machine cycle. This has the benefit of creating unique structural moldings with one or more colors, durometer, and/or material property. The bond between the two materials if dissimilar may be mechanical, or in other cases, may be chemical, depending on the choice or combination of materials. This manufacturing technique may produce optimized or desired mechanical properties of the device with good repeatability at low cost.

One advantage of using two material with different durometers for the curved continuous concave channel and the bite partition may be such that, for example the channel are rigid enough to support the forces associated with retraction of the lips and yet flexible enough to be inserted into a multitude of various mouth sizes. The bite partition on the other hand may be softer so that it may provide more comfort for the patient when the patient bites down onto it, while supporting the jaw for at least the time needed to perform a procedure. The typical durometer range for the curved continuous concave channel may be, for example, from about 65 to about 95 Shore A hardness. The typical durometer range for the bite partition may be for example, from around 30 to about 65 Shore A hardness, but may also be as high as 90 Shore A hardness and still be comfortable. The device may be manufactured from various thermoplastics as well as thermosetting materials. Various polymers may be utilized to create the device and may include thermoplastic elastomers, Silicon, Polyolefins, Polycarbonate, Acrylonitrile butadiene styrene, High impact polystyrene, Polyamide, cyclic olefin copolymer, Polylactic acid, Polypropylene, Polyethylene, cellulosics, Thermoplastic vulcinates, Rubber, latex, polyoxymethylene, Polymethylmethacralate, polyvinylchloride, polyurethane, Polyester or similar or combinations therefore.

The device may be re-usable or disposable. When selecting the material for the manufacturing of the device, a material that allows the device to be disposable may be selected to maintain efficacy in use. If the material is chosen for sterilization, then the material may include those able to withstand whatever sterilization processes the device will be subjected to without significant degradation of the material.

In yet another embodiment, an absorbing, UV protective cloth or bib may be permanently or temporary attached to the front side of the device. This may help to absorb any excess saliva that may exude from the patient's mouth during a dental process, and also may provide for a barrier from any unintended UV exposure. In the permanently attached bib version, a user may be deterred from attempting to reuse the device on another patient after re-sterilization.

In one exemplary embodiment, a curved notch may be present at the top of the device on the front and/or the backside about the middle of the front and rear walls. The notch may provide a recess for the nose on the front side and also the (skin attachment) portion between the upper lip and the gums on the backside of the device at the top inside of the mouth. The notch may be of a shape designed to maximize comfort for the patient.

The cylindrical shape formation may be connected or attached to an aspirator, for aspirating a patient during a dental process, as noted above. The connection may be effected through pliable or flexible tubing that may be amenable for aspiring.

The tubing may be connected to a central remote vacuum pump. The operatory suction tubing may also employ a Y-shaped fitting so that multiple saliva aspirators may be simultaneously used during a patient's treatment if needed. The cylindrical formation may be formed of a harder material than the tubing section. The tubing section and the cylindrical formation may be structurally joined to form a single unit.

Other variations and equivalent structures of the present invention are also contemplated to be within the scope of the present invention and may be described herein and further discussed below in the Detailed Description section.

### BRIEF DESCRIPTION OF THE DRAWINGS

FIG. 1 shows a rear isometric view of an embodiment of a retracting device of the present invention;

FIG. 2 shows a front side isometric view of the retracting device of FIG. 1;

FIG. 3 shows a bottom view of the retracting device of FIG. 1;

FIG. 4 shows a rear isometric view of another embodiment of a retracting device of the present invention;

FIG. 5 shows a front side view of the retracting device of FIG. 4;

FIG. 6 shows a bottom view of the retracting device of FIG. 4;

FIG. 7 shows an exploded view of the retracting device of FIG. 4 and a light guide;

FIG. 8 is an isometric view of the retracting device of FIG. 4 attached to a p system;

FIG. 9 shows a front view of a retracting device after insertion into a patient's mouth;

FIG. 10 shows a front isometric view of an embodiment of a retracting device having a bib attached over the top of the front of the retracting device;

FIG. 11 shows a front isometric view of an embodiment of a retractor device having a bib attached to the inside front wall of the curved continuous concave channel;

FIG. 12 shows an embodiment of a retracting device having an aspiring tube connected to an aspirator;

FIG. 13 shows a rear isometric view of an embodiment of a retracting device adapted for aspiration of the present invention;

FIG. 14 shows a cross section of the aspiration block;

FIG. 15 shows a top view of the aspiration block;

FIG. 16 shows a rear isometric view of the retracting device during a two shot injection molding process;

FIG. 17 shows a front isometric view of an embodiment of a retracting device with bite block of the present invention; and

FIG. 18 shows a front and rear isometric view of a retracting device of the present invention;

### DETAILED DESCRIPTION OF THE INVENTION

The detailed description set forth below is intended as a description of the presently exemplified device provided in accordance with aspects of the present invention and is not intended to represent the only forms in which the present invention may be practiced or utilized. It is to be understood, however, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

While the present invention is open to various modifications and alternative constructions, the embodiments shown in the drawings will be described herein in detail. It is to be understood, however, there is no intention to limit the invention to the particular form disclosed. On the contrary, it is intended that the invention cover all modifications, equivalences and alternative constructions falling within the spirit and scope of the invention as expressed in the appended claims.

The invention relates to a retraction device for retracting a patient's lips during a dental procedure to expose portions of the teeth and gums for treatment or viewing. In one embodiment, the device may be used during an in-office teeth whitening procedure, for example a Zoom®! teeth whitening and/or BriteSmile® teeth whitening procedure.

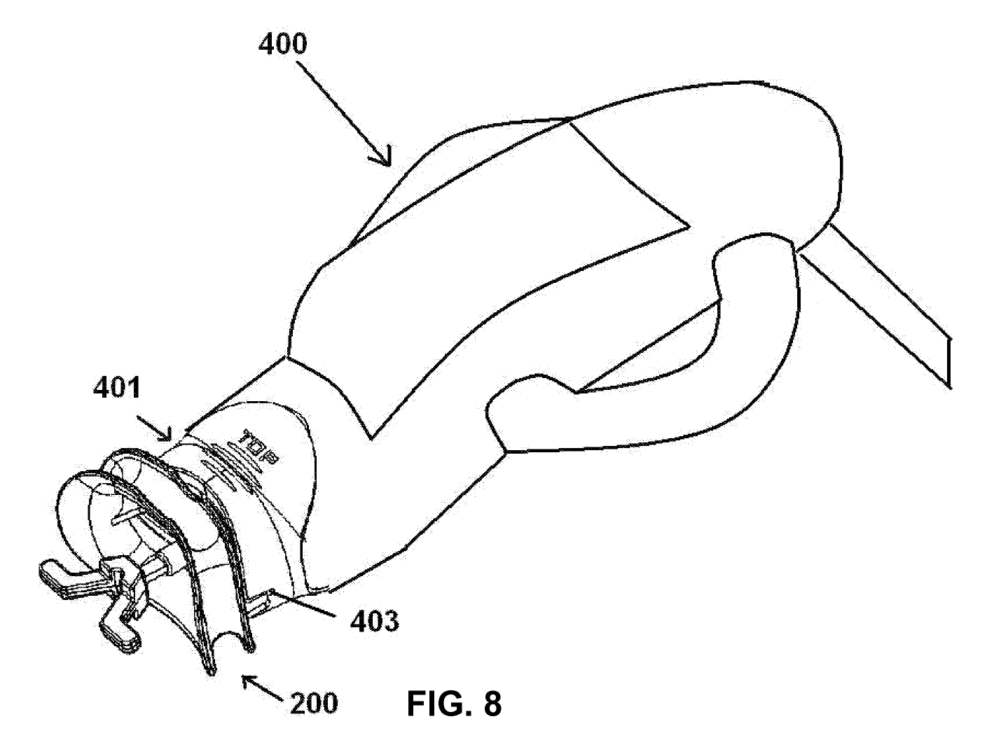

The device may be inserted into the patient's mouth typically by any dental professional, for example, an individual overseeing the whitening procedure, typically a dentist, dental hygienist, or assistant. Once the retracting device is in place, the hygienist may place saliva collection rolls and/or protective UV curable dental dam along the gums above the teeth to protect the gums, for example, from exposure during whitening. The dental dam may also provide protection for the gums from the activated peroxide gel and/or protection from any UV output of a lamp 400, as shown in FIG. 8, to be described more fully below.

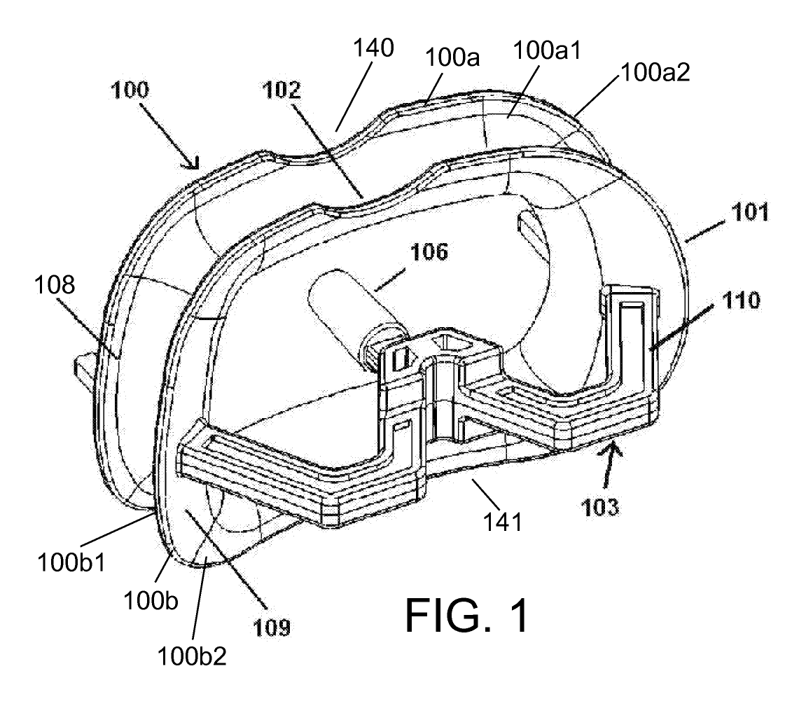

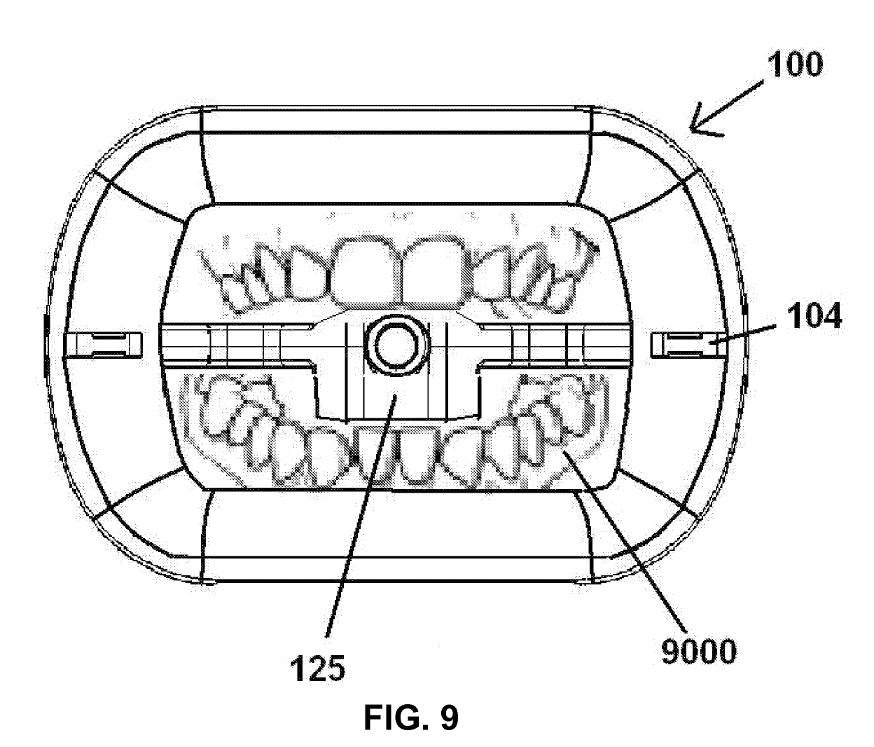

A rear view of an example of a retracting device 100 is shown in FIG. 1. The retracting device 100 includes a front wall 100a and a rear wall 100b, enclosing a curved, continuous channel 108 adapted for receiving the lips of a patient when the device is placed into the mouth of a patient, as shown in FIG. 9. The front wall 100a has an inside surface 100a1 and an outside surface 100a2. Likewise, the rear 100b wall each has an inside surface 100b1 and an outside surface 100b2. The outside surfaces of both walls are the surfaces away from the channel 108. In one embodiment, the walls 100a and 100b may be curve about the top 140 and side portions 101, but substantially straight about the bottom portion 141.

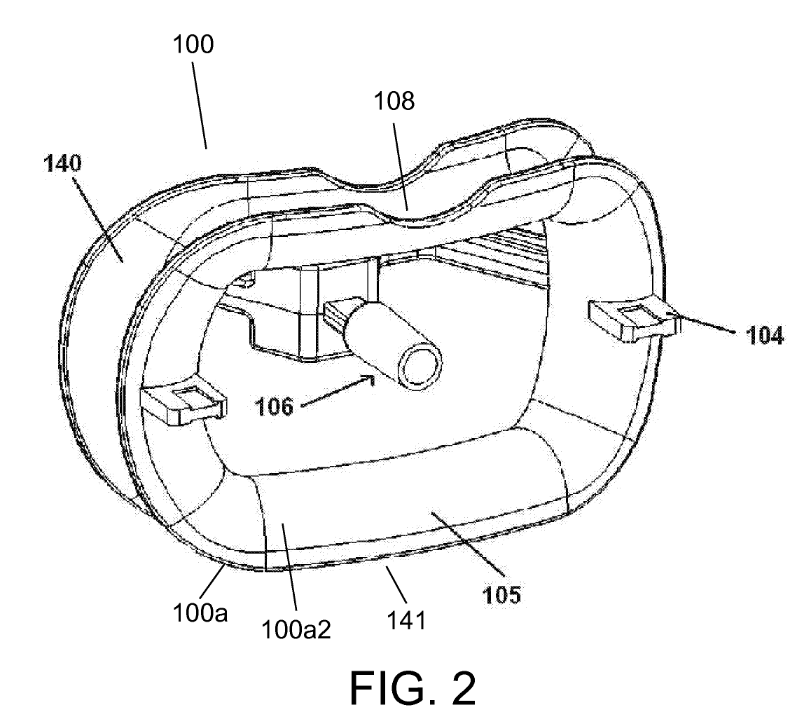

FIG. 2 shows the retracting device 100 of FIG. 1, viewing from the front side. As shown, the outside view of the concave channel 108 at the bottom portion 141 may be saddle-shape, as shown as 105. Variations may be used as long as they conform substantially to the lips of a patient. This portion 105 may be opaque, to protect the patient's lips from unintended exposure of heat and/or UV light that a whitening lamp 400, for example, may give off during a whitening procedure. Alignment formations, for example, tabs 104 may be present, positioned or attached to the outside surface 100a2 of the front wall 100a about the side portion 101 to allow the retracting device 100 to align with a light system, for example, the Zoom® lamp, shown as 400 in FIG. 8.

As discussed before, the alignment formations 104 may be of any shape, as long as they are adapted for matting, engaging or inter-engaging with a corresponding feature in a lamp system 400. In one embodiment, this alignment formation 104 may include two symmetrical formations 104, one on either side portion 101 of the device 100. The formations 104 may be formed or present on the outside surface 100a2 of the front wall 100a. In one aspect, the formations 104 may be in the form of protrusions 104, protruding from the outer surface 100a2 of the front wall 100a of the side portion 101. According to one embodiment, the protrusion 104 may be in the shape of a rectangular peg, as shown in FIG. 2, having a rectangular cross-section. According to another embodiment, the protrusion 104 may be in the shape of a square peg, not specifically shown. According to yet another embodiment, the protrusion 104 may be in the form of a circular peg, also not specifically shown.

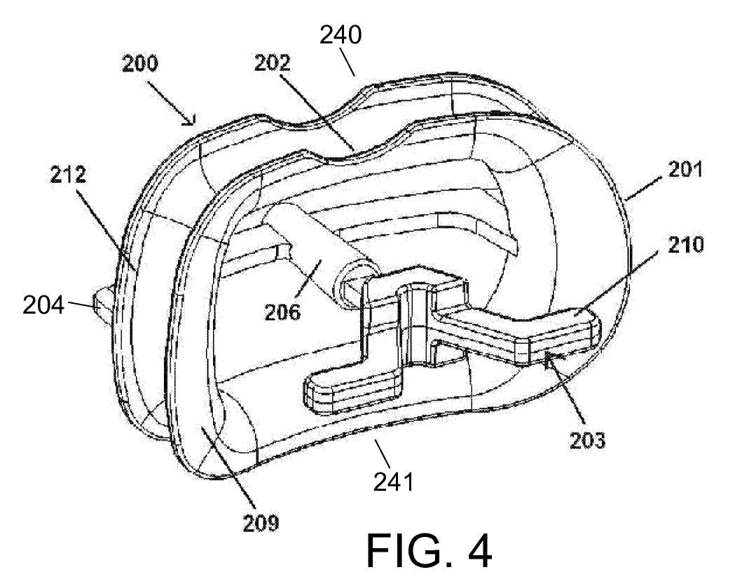

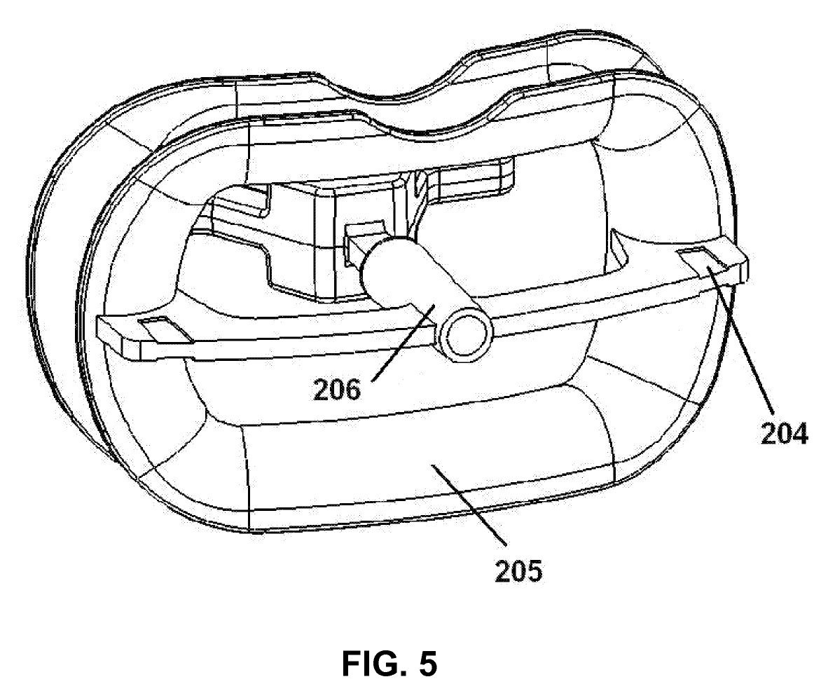

In another embodiment, this alignment formation may be created by a continuous blade-like feature 204 that spans the entire front portion of the device 200, from side to side, as shown in FIGS. 4 and 5.

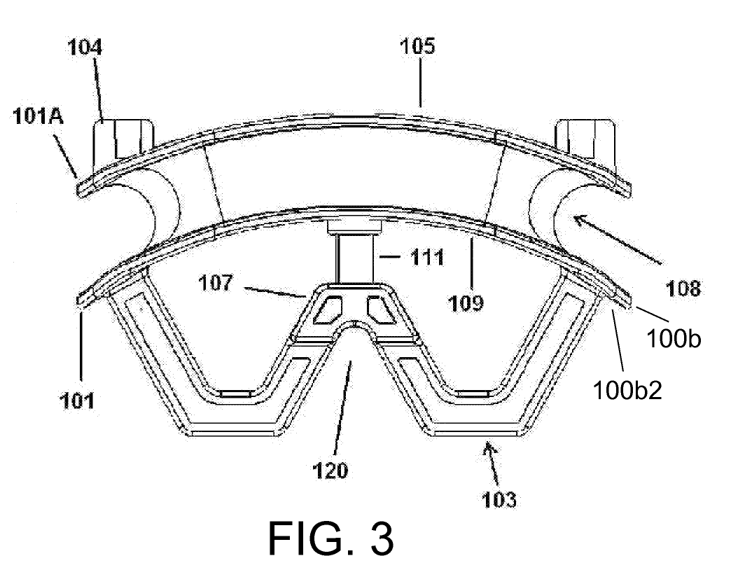

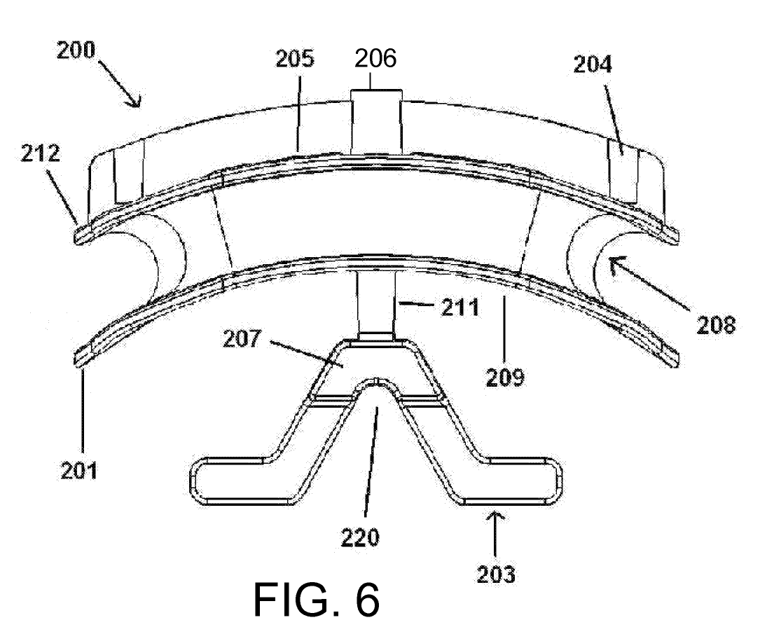

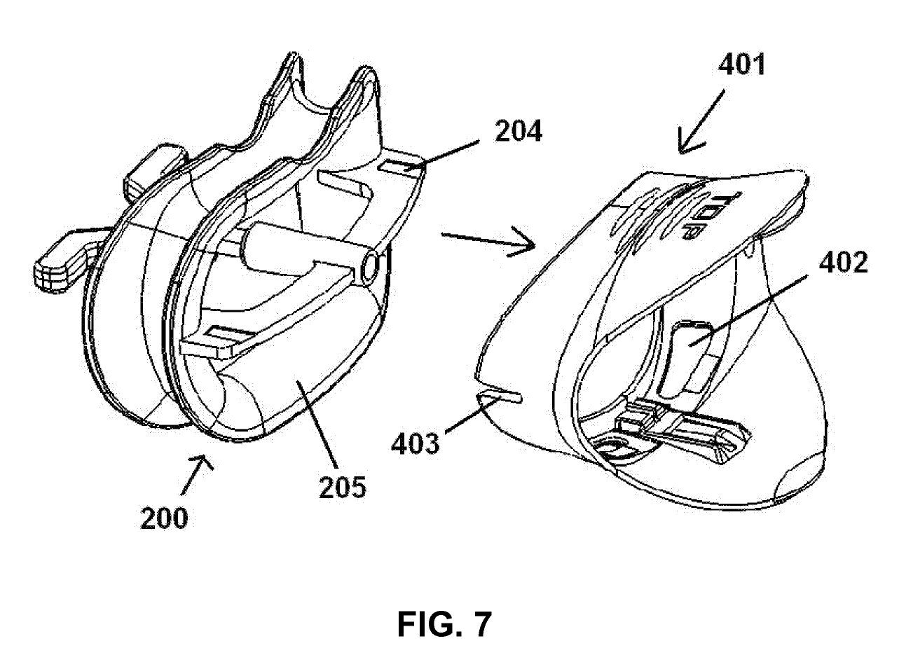

FIG. 3 shows a top view of alignment features 104 that align to the light guide 401, as shown in an exploded view in FIG. 7. The lips reside in the continuous concave channel 108. In one embodiment, region 107, as shown in FIG. 3, or 207, as shown in FIG. 6, of the retracting device 100 or 200, is adapted for helping to block any unintended light from coming into the mouth and reaching the tongue and/or the back of the throat. In another embodiment, more portions of the retracting device may also be opaque.

A bite device 103, having a suitable geometry may be attached to, positioned, extended from the outside surface 100b2 of the rear wall 100b, as shown in FIG. 1, and may be, as noted above, used as a comfortable jaw rest or bite partition. In one aspect, a bite device 103 or 203 having a suitable geometry may be attached to, for example, the rear surface 100b2 of the rear wall 100b forming the continuous channel 108, and may be, as noted above, used as a comfortable jaw rest or bite partition.

The bite partition 103 may allow for appropriate spacing between the upper and lower teeth, and may also allow for a comfortable rest for the jaw. Since the time for a procedure may typically be as long, for example, as much as sixty minutes or longer, the bite partition 103 may be manufactured from a soft or resilient material. In one embodiment, the bite partition 103 may be manufactured to be soft or resilient while the continuous channel 108 that retracts the upper and lower lips may be made to be stiffer, yet flexible. In another embodiment, both the bite partition 103 and the channel 108 may be of the same or similar softness.

The bite device 103 may be in the shape of an “M”, adapted for extending into the oral cavity during use. The side portions 101 may be flexible so that it may typically deformed or flexed towards the “M” shape section 103 from both sides to allow the device 100 to enter the oral cavity. Cutouts or depressions 102, from FIG. 1, on the top surfaces of the walls 100a and 100b may be present to allow for clearance from the nose as well as clearance from the skin inside of the mouth that connects the lip to the gums.

The bite device 103 may allow for appropriate spacing between the upper and lower teeth, in addition to allow for a comfortable rest for the jaw, as noted above.

The bite device 103 may also have a tongue cup 120. Tongue cup 120 serves to restrict the movement of the patient's tongue so it will not interfere during a dental procedure while maintaining patient comfort. In procedures where high intensity light is directed into a patient's oral cavity, such as a light assisted tooth whitening procedure, for example, ZOOM® or BriteSmile®, tongue cup 120 may serve an additional function. In such procedures, tongue cup 120 may serve to block some of the high intensity light direct into the oral cavity, thus protecting the soft tissue of the tongue from potentially hazardous high intensity light.

Since the time for a procedure may typically be as long, for example, as much as sixty minutes or longer, the bite partition 103 may be manufactured from a soft or resilient material.

In one embodiment, the bite partition 103 may be in the shape of a letter “M”, as shown in FIG. 1. The legs 110 of the “M” shape 103 may extend from or be attached to the outside surface 100b2 of the rear wall 100b of the continuous channel 108, substantially symmetrically about the device 100 from side to side, one leg on each side. The backside of the bite partition 103 may extend into the oral cavity during use, while the front side may not completely enter into the oral cavity during use. The “M” shape 103 is shaped to allow for proper support of the upper and lower lips and also to allow for maximum access to the teeth during treatment. For example, the first molar or #3 to #14 teeth may be substantially exposed when the retracting device 100 is in use.

According to one embodiment, the “M” shape section 103 may be typically of a lower durometer than curved continuous concave channel 108 to allow for a comfortable surface for a patient to bite down for example, at position 110, while the higher durometer of the channel 108 may have enough rigidity to retract the lips when in use. In this embodiment, the bite partition 103 may be manufactured to be soft or resilient while the continuous channel 108 that retracts the upper and lower lips may be made to be stiffer, yet flexible. In another embodiment, both the bite partition 103 and the channel 108 may be of the same or similar durometer or hardness.

In any of these embodiments, the “M” shape bite partition 103 may have attached to it or extends from it, a substantially cylindrical formation 106, as discussed above, that may extend towards the front side of the partition 103. The cylindrical formation 106 may extend from or be attached to the “M” shape 103 at the center or bottom 103a of the “M”. The formation 106 may be used with, for example, the BriteSmile® whitening system and thus may also act as an alignment feature 104 to the lamp 400.

In another embodiment, the bite partition 203 may include a geometry similar in shape to that of a “Y” except the “Y” shape may have on each side, as shown in FIG. 4, an extension 210 that extends symmetrically and parallel to the upper and lower portions 240 and 241, towards the cheeks when the device 200 is inserted into the oral cavity.

In still another embodiment, the bite partition 103 may have the “M” geometry without the legs 110 of the “M” being connected or attached to outside surface 100b2 of the side portion 101 of the rear wall 100b of the curved continuous concave channel 108, as shown in FIG. 3.

In yet still another embodiment, the “Y” shape bite device 108 may be attached to or integral with an alignment center blade 204 that spans continuously across the outside surface 200a2 of the front side 200a of the device 200, as shown in FIG. 5. The attachment point may be to the front side 200a of the device 200. This embodiment may also allow for added flexibility of the flange 209 so that the flange 209 may flex easily while being placed into the oral cavity while still maintains enough rigidity to retract the lips. In this embodiment, the cylindrical shape formation 206 may also be attached to or form part of the leg of the Y shape formation 203.

In one embodiment, the device 100 or 200 may include a substantially cylindrical shape formation 106 or 206, as shown in FIGS. 1, 2 4 and 5, having an appropriate diameter, useful for alignment and orientation to other whitening systems 400, such as the BriteSmile® whitening system.

According to one embodiment, the cylindrical shape formation 106 or 206 may protrude from the main body of the bite partition 103, as shown in FIGS. 1 and 2.

According to another embodiment, the cylindrical shape formation 106 may be connected to the alignment formation 204, as shown in FIGS. 4 and 5.

According to yet another embodiment, the cylindrical shape formation 106 or 206 may be part of a bite device 103 or 203, as noted above.

Referring to FIG. 4 again, the retracting device 200 with the “Y” shaped bite partition 203 may be placed into the mouth of a subject, as shown in FIG. 9, with the “Y” shape bite partition 203 extending into the mouth. The flexible member or flange 201 is typically deformed or flexed inwards towards the “Y” shape bite partition 203 from both sides to allow the device to enter the oral cavity. As noted above, indents or cutouts 202 may allow for clearance from the nose as well as clearance from the skin member inside of the mouth that connects the lip to the gums. The “Y” shape bite partition 203 is also typically of a lower durometer than curved continuous concave channel 208, as noted above, to allow for a comfortable surface for a patient to bite down for example, at position 210, while the higher durometer of the channel 208 may have enough rigidity to retract the lips when in use. In this embodiment, the bite partition 203 may be manufactured to be soft or resilient while the continuous channel 208 that retracts the upper and lower lips may be made to be stiffer, yet flexible. In another embodiment, both the bite partition 203 and the channel 208 may be of the same or similar durometer or hardness.

For the bite partitions or devices 103 or 203 that may or may not be attached to, or extended from, the outside surface 100b1 of the rear wall 100b, a member 111, or 211, as shown in FIG. 3 or 6, may connect or attach the bite partition 103 or 203 to an alignment feature 106 or 206 of FIGS. 3 and 6.

Similar to FIG. 2, the front side of the retracting device 200 of FIG. 5, is also shown to be continuous at surface 205. This surface 205 may again be opaque to protect the patient's lips from unintended exposure from heat and UV light that the whitening lamp may give off during the whitening procedure. In FIG. 5, an alignment feature 204 is shown as an alignment wing or blade 204, that can align the retracting device 200 with a light guide 401, as shown in FIG. 7, when the retracting device 200 is used with a lamp system 400, for example, the Zoom®! lamp as seen if FIG. 8.

FIG. 6 shows a top view of alignment features 204 that align to the light guide 401 shown in FIG. 7. Region 205 is the front surface of the device 200 and region 209 is the backside surface of the device 200. The lips may reside in the continuous concave channel 208 during use. Region 207 may be used to help block any unintended light from coming into the mouth and reaching the tongue and/or the back of the throat. A member 211 connects the bite partition 203 to the alignment feature 206, and the bite partition 203 is not otherwise connected to the main body of the retracting device 200.

As noted above, FIG. 7 shows an exploded view of a retracting device 200 in connection with a light guide 401 through the matting of the formation, for example, alignment feature 204, on the retracing device, and the formations, for example, slots 403 on the light guide 401. Details of the light guide may be found in U.S. application Ser. Nos. 11/173,839 and 11/173,734, the contents of all are hereby incorporated by reference.

FIG. 9 shows an embodiment of a retracting device 100, as noted above. The lamp system 400, as shown in FIG. 8, mates with alignment formation 104.

FIG. 8 shows an embodiment of a retracting device 200 attached to a lamp system 400 having a light guide 401 interposed between the lamp and the retracting device 200.

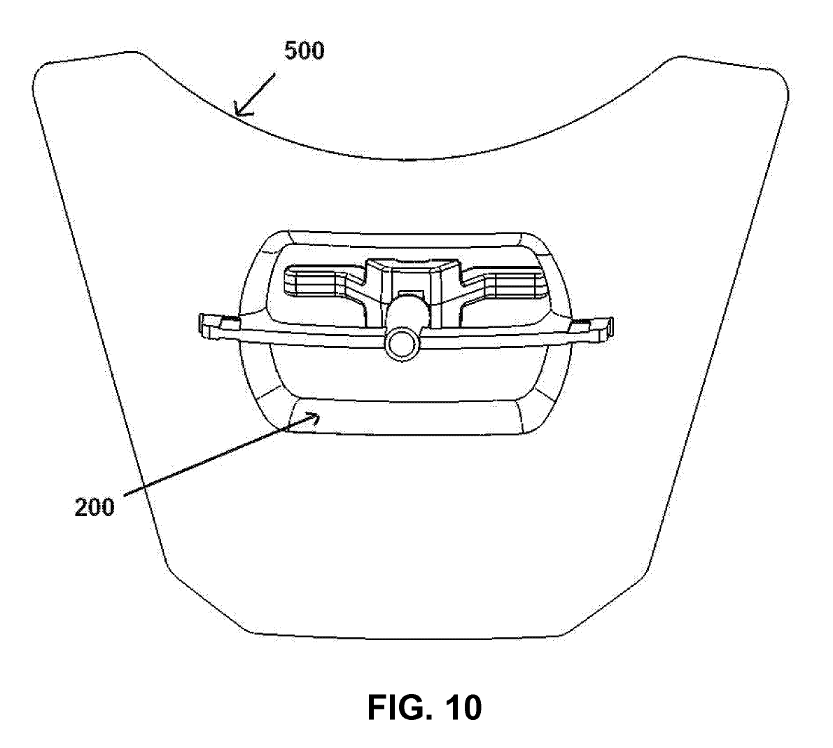

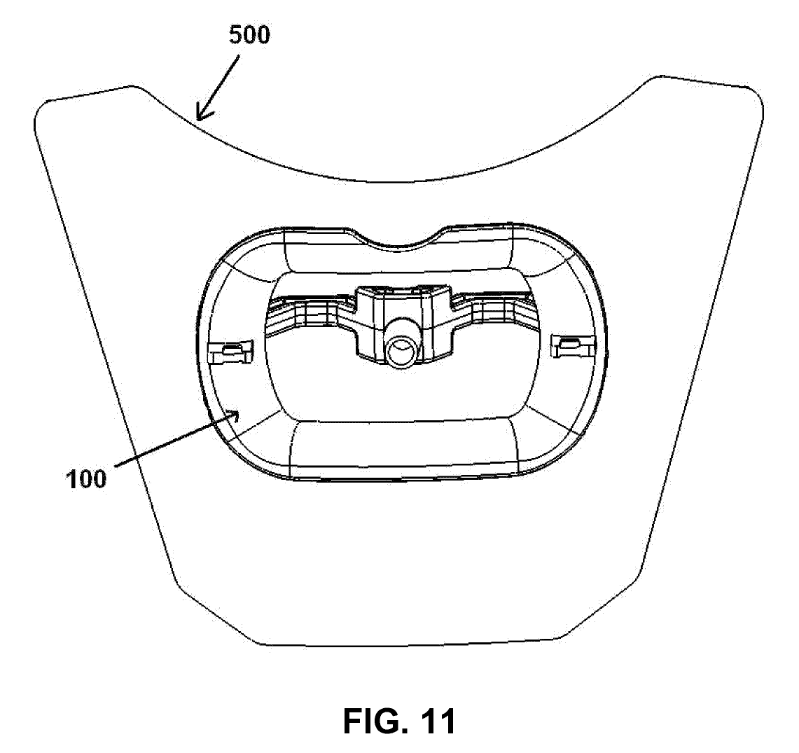

FIG. 10 shows a front isometric view of a retracting device 200 having a bib 500. The bib 500 may come in various shapes and sizes without going beyond the scope of the invention. The bib 500 may be used during whitening or other dental procedures to protect portions of the face, for example, the extremities of the face, from any unintended heat or light and may also be adapted for absorbing any excess saliva that may exude from the patient's mouth during the procedure. In one embodiment, the bib 500 may be formed as part of the retracting device 200. In another embodiment, the bib 500 may be held in place by the alignment device 204, as shown in FIG. 10. In yet another embodiment, as shown in FIG. 11 which depicts a front isometric view of a retracting 100 with bib 500 actually placed or attached to the inside of continuous concave channel 108. One advantage of this orientation of the bib 500 would be that it may not be necessary to physically attach bib 500 to the retracting device 100, rather it could be stretched or assembled over continuous concave channels 108 or 208 in order to mechanically hold it in the correct orientation.

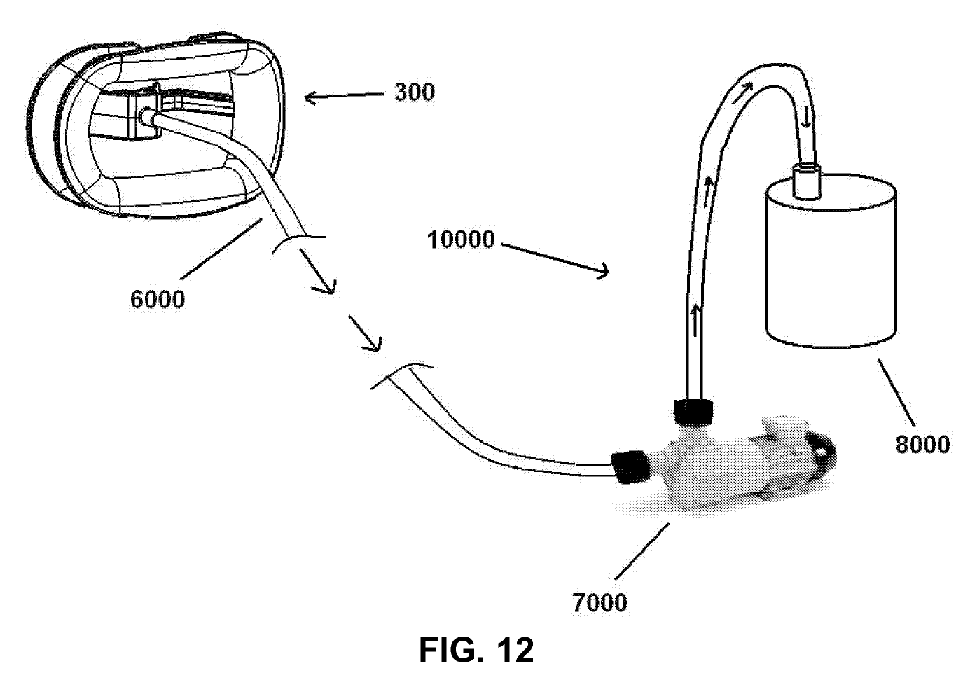

FIG. 12 shows another embodiment of this invention in which the retractor 300 is adapted for aspiration of fluids from the patient's oral cavity. In this embodiment, retractor 300 is connected to a vacuum 7000 by vacuum tubing 6000. The vacuum 7000 is connected to the reservoir 8000 by the reservoir tubing 10000. The vacuum 7000 is a source of suction force which sucks saliva from the patient's oral cavity through the retractor 300 through the vacuum tubing 6000 and then the reservoir tubing 10000 for deposition into the reservoir 8000. Other embodiments of this invention will have an integrated vacuum 7000 and reservoir 8000 so that reservoir tubing 10000 will not be needed.

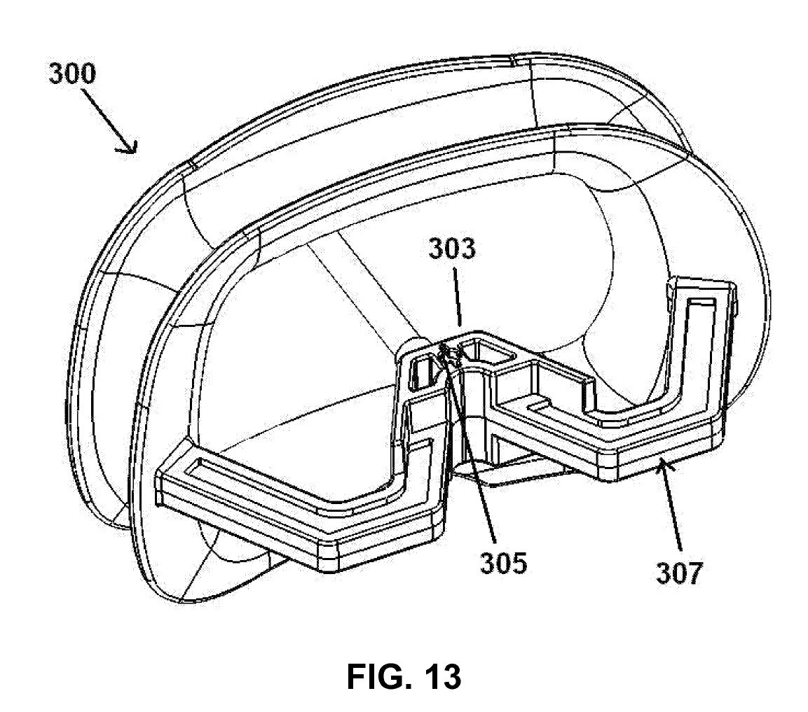

FIGS. 13 to 15 and 17 provide details on adapting the retractor for aspiration.

FIG. 13 is a rear isometric view of a retractor 300 adapted for aspiration. The retractor adapted for aspiration 300 has a bite block 307. Connected to bite block 307 is aspiration block 303. Located on aspiration block 303 is aspiration inlet 305. In some embodiments, aspiration block 303 can also act as a light block. Such a light block has utility in dental procedures involving shining intense light into the oral cavity, such as the ZOOM® and BriteSmile® teeth whitening procedure. By acting as a light block, aspiration block 303, limits exposure of the tongue's soft tissue to intense light.

The aspiration block 303 as shown is FIG. 13 is adapted to provide aspiration of fluids from a patient's tongue. However, other areas of the patient's oral cavity can be aspirated by this invention depending on the location of the aspiration block 303 on bite block 207 relative to the patient's oral cavity.

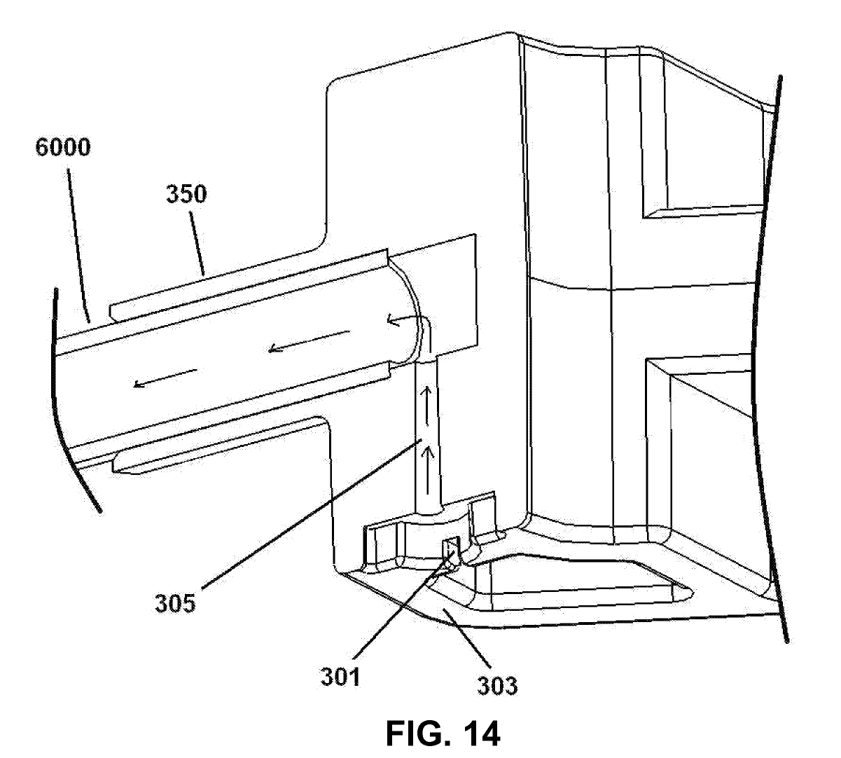

FIG. 14 is a cross section view of aspiration block 303. Inside of aspiration block 303 is aspiration inlet 305. Vacuum tubing 6000 connects to cylindrical formation 350, which is connected to aspiration inlet 305. Saliva travels from the patient's oral cavity through aspiration inlet 305. From the aspiration inlet 305, the saliva travels through the vacuum tubing 6000.

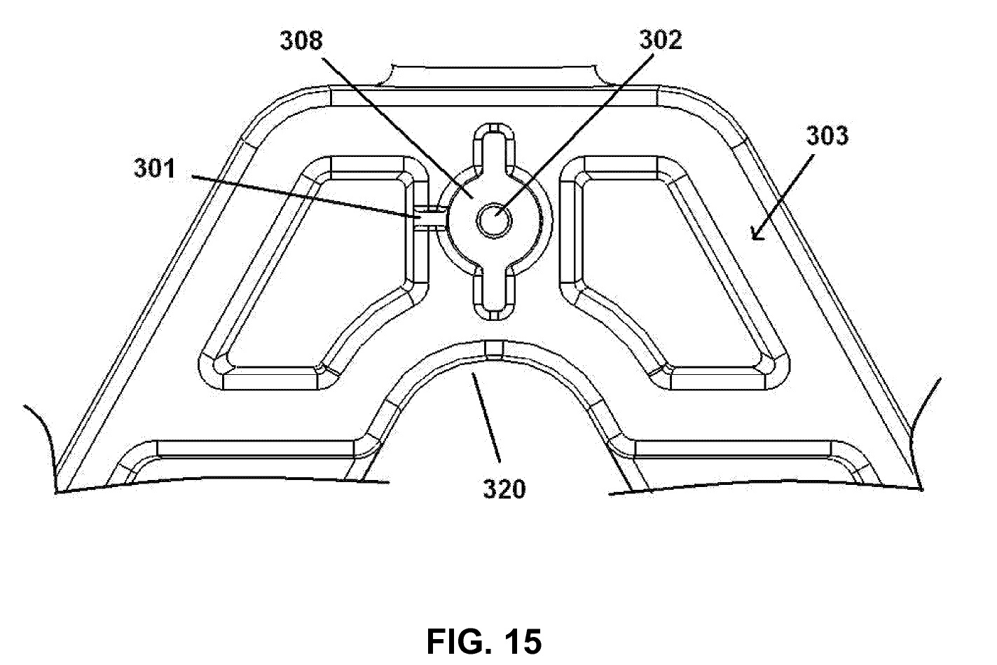

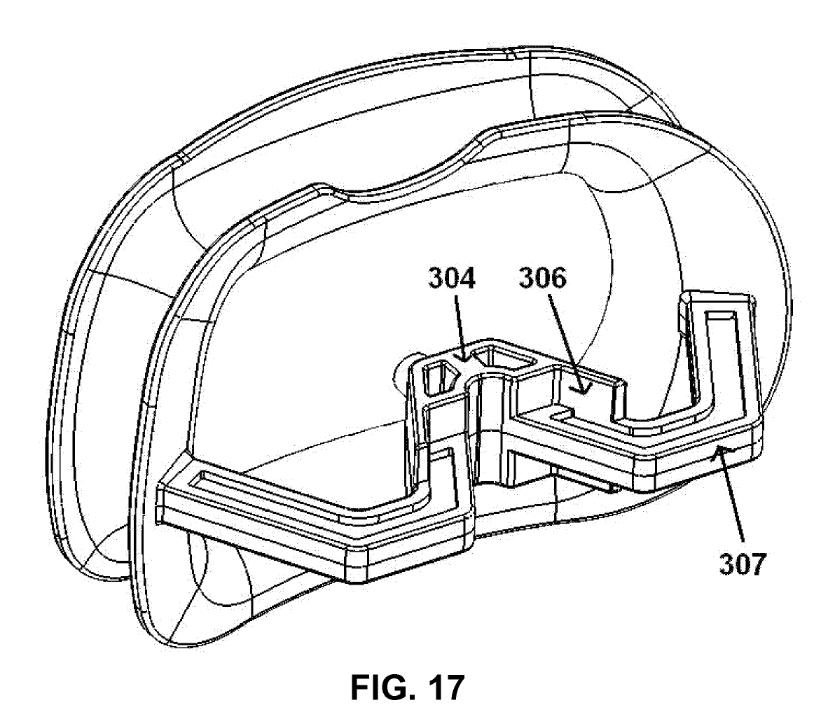

FIG. 15 is an elevated view of the area of the aspiration block 303 where the aspiration inlet 305 is located. Aspiration hole 302 is located at the end of aspiration inlet 305 and is where the fluids passes into the aspiration inlet 305. Suction area 308 is the area immediately below the aspiration hole 302 that is aspirated by the suction force generated by the vacuum 7000. FIG. 17 is another rear isometric view of retractor 300 adapted for aspiration and shows the side opposite of what is shown in FIG. 15. Center block 304 contains the aspiration inlet 305 and is closed at the end opposite of the aspiration hole 302.

As discussed above, this particular embodiment is for the aspiration of fluids on a patient's tongue. As such, aspiration block 303 rests on the patient's tongue and fluids are sucked through aspiration hole 302. Aspiration block 303 has a series of walls to maintain rigidity of the aspiration block 303, but also serves to limit the area in which the fluids are aspirated. Through hole 301 extends from suction area 308 and is a means to extend the area by which the suction force acts on by permitting aspiration of areas outside of the suction area 308. Depending on the area of the oral cavity to be aspirated and the location of the aspiration block relative to the oral cavity, there are other means to expand the area of aspiration.

The preferred method of manufacturing the retractor of this invention is through a two-shot injection molding process. Two shot injection molding may have the ability to produce complex structures, using one or two different polymers at the same time during one machine cycle. This has the benefit of creating unique structural moldings with one or more colors, durometer, and/or material property. The bond between the two materials if dissimilar may be mechanical, or in other cases, may be chemical, depending on the choice or combination of materials. This manufacturing technique may produce optimized or desired mechanical properties of the device with good repeatability at low cost.

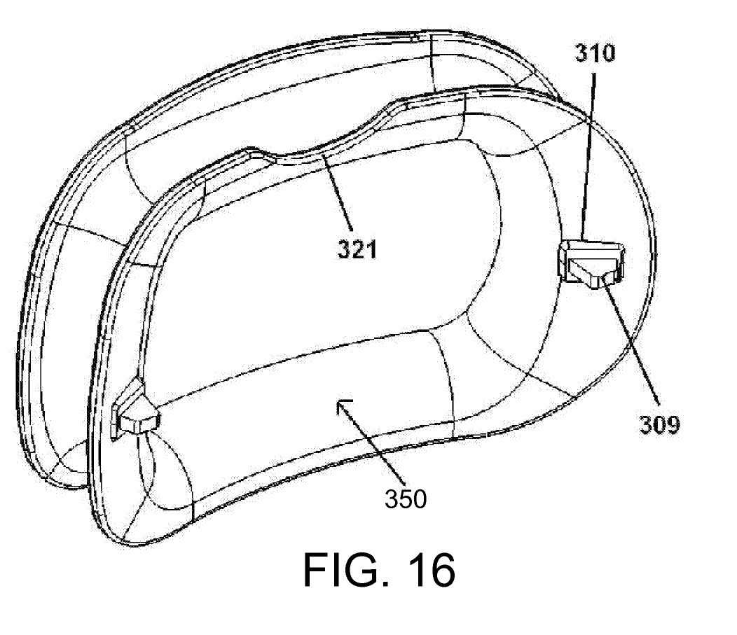

FIG. 16 is a rear isometric view of the retractor main body 350 during the two shot injection molding process. Retractor main body 350 is injection molded first. Tabs 309 and anchor 310 are molded as part of the retractor main body 350. The bite block is injection molded second, onto retractor main body 350. The tabs 309 and anchor 310 allows the bite block to be securely injection molded onto the retractor main body 350. Tabs 309 and anchor 310 also allows for accurate placement of the bite block onto retractor main body 350.

In one embodiment of the invention, both the retractor main body 350 and bite block are constructed of the same material. In another embodiment of the invention the retractor main body 350 is constructed of a different material than the bite block. The typical durometer range for the retractor main body may be, for example, from about 65 to about 95 Shore A hardness. The typical durometer range for the bite partition may be for example, from around 30 to about 65 Shore A hardness, but may also be as high as 90 Shore A hardness and still be comfortable. One advantage of using two material with different durometers for the retractor main body 350 and the bite block is that the retractor main body is rigid enough to support the forces associated with retraction of the lips and yet flexible enough to be inserted into a multitude of various mouth sizes. The bite partition on the other hand is softer so that it may provide more comfort for the patient when the patient bites down onto it, while supporting the jaw for at least the time needed to perform a procedure.

The device may be manufactured from various thermoplastics as well as thermosetting materials. Various polymers may be utilized to create the device and may include thermoplastic elastomers, Silicon, Polyolefins, Polycarbonate, Acrylonitrile butadiene styrene, High impact polystyrene, Polyamide, cyclic olefin copolymer, Polylactic acid, Polypropylene, Polyethylene, cellulosics, Thermoplastic vulcinates, Rubber, latex, polyoxymethylene, Polymethylmethacralate, polyvinylchloride, polyurethane, Polyester or similar or combinations therefore.

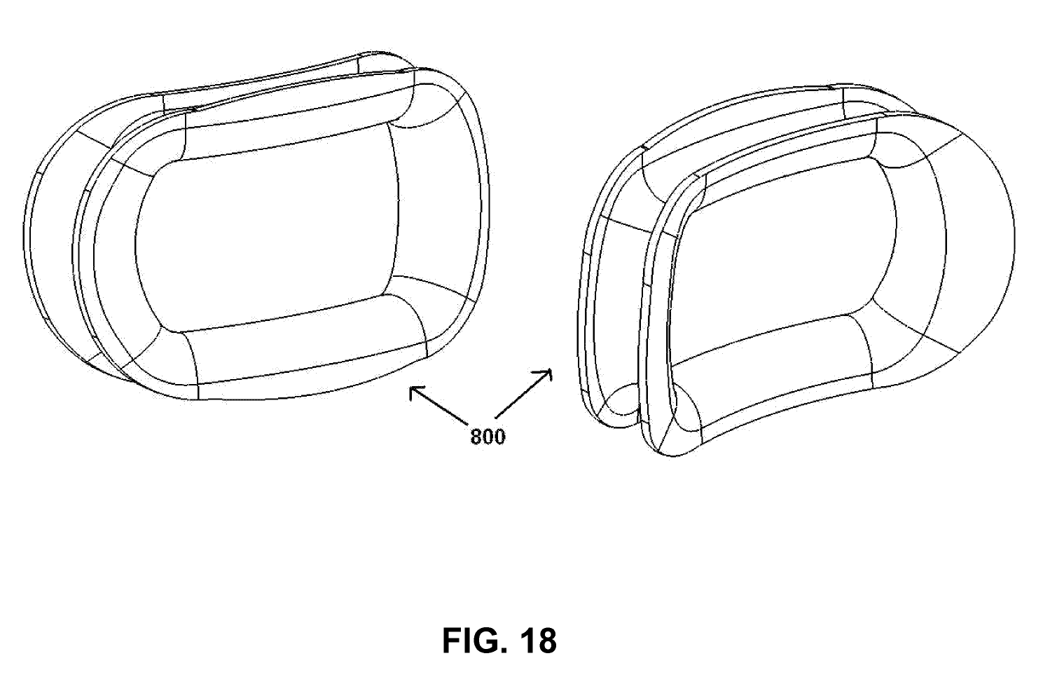

FIG. 18 is a front and rear isometric view of a retractor 800. In this embodiment of the present invention, retractor 800 does not have a bite block or formations. This embodiment of the invention would be for situations where the dental professional desires to have the patient's lips and cheeks retracted to be provided with a clearer view of the patient's oral cavity.

While exemplified embodiments of the invention have been described and illustrated above, it should be understood that these are exemplary of the invention and are not to be considered as limiting. Accordingly, the invention is not to be considered as limited by the foregoing description, but is only limited by the scope of the claims appended hereto.

1. A lip and cheek retracting device comprising a main body portion with a front wall, a rear wall and a bottom portion defining a continuous concave channel utilized to retract a human's lips.

2. The device of claim 1 wherein the continuous concave channel is in the size and shape appropriate to completely retract a humans lips in order to expose the teeth.

3. The device of claim 1, wherein the continuous concave channel is of appropriate rigidity and flexibility to appropriately retract a human's lips in order to expose the teeth and gums.

4. The device of claim 1, wherein the continuous concave channel has a front and back surface.

5. The device of claim 1, wherein the front surface has an alignment feature utilized for alignment to a dental lamp or other equipment.

6. The device of claim 1 further comprising a bite block utilized to separate the teeth from overlapping each other in order to have full frontal unobstructed view of each tooth.

7. The device of claim 6, wherein the bite block is made from a soft pliable polymer.

8. The device of claim 6, wherein the bite block is connected to the backside of the continuous concave channel.

9. The device of claim 6 wherein said bite block is in the shape of an “M”.

10. The device of claim 6 where said bite block is in the shape of a “Y”.

11. The device of claim 6, wherein the bite block is connected to the front side of the continuous concave channel.

12. The device of claim 6 wherein bite block is constructed from a soft polymer.

13. The device of claim 6 where said main body portion has a durometer of about 65 to about 85 Shore A hardness.

14. The device of claim 6 wherein said bite device has a durometer of about 60 to about 65 Shore A hardness.

15. The device of claim 12 is constructed from a group comprising of thermoplastic elastomers such as silicon, polyolefins, polycarbonate, acrylonitrile butadiene styrene, high impact polystyrene, polyamide, cyclic olefin copolymer, polylactic acid, polypropylene, polyethylene, cellulosics, thermoplastic vulcinates, rubber, latex, polyoxymethylene, polymethylmethacralate, polyvinylchloride, polyurethane, polyester or similar or combinations therefore.

16. The device of claim 1 further comprising a bib of UV resistant material.

17. The device of claim 6 further comprising a tongue cup.

18. A lip and cheek retracting device comprising:
a main body portion with a front wall, a rear wall, and a bottom portion defining a continuous concave channel utilized to retract a human's lips;
a bite block connected to the backside of said continuous concave channel; and
an aspirator inlet connected to said bite block adapted to be connected to a vacuum source.

19. A kit for aspirating an oral cavity comprising:
a retractor comprising of a main body portion, a bite block coupled to said main body portion, and an aspirator block coupled to said bite block;
a vacuum source coupled to said aspirator block; and
a reservoir coupled to said vacuum source.

20. A method of constructing a lip and cheek retractor comprising: a two shot injection molding process comprising:
A first injection molding of a main body portion comprising a front wall, a rear wall, a bottom portion defining a continuous concave channel, at least two anchors and at least one tab molded on each of said anchor; and
a second injection molding of a bite block onto said at least one tab molded on said anchor molded on said main body portion.

21. The method of claim 18 wherein said main body portion is injection molded from a material with a durometer of about 65 to about 85 Shore A hardness and said bite device is molded from a material with a durometer of about 60 to about 65 Shore A hardness.
